(19) United States
(12) Patent Application Publication
(10) Pub. No.: US 2015/0035760 A1
(43) Pub. Date: Feb. 5, 2015

(54) CONTROL SYSTEM AND METHOD FOR DEFINING FUNCTION THEREOF

(71) Applicant: Wistron Corporation, New Taipei City (TW)

(72) Inventors: Wen-Chin Wu, New Taipei City (TW); Yi-Sheng Kao, New Taipei City (TW)

(73) Assignee: Wistron Corporation, New Taipei City (TW)

(21) Appl. No.: 14/133,676

(22) Filed: Dec. 19, 2013

(30) Foreign Application Priority Data
Jul. 31, 2013 (TW) 102127496

(51) Int. Cl. G06F 3/041

(52) U.S. Cl. CPC G06F 3/041
USPC 345/173

(57) ABSTRACT

A control system and a method for defining function thereof are provided. The control system includes a touchpad and a key sheet, wherein the touchpad includes a touch sensing surface and the key sheet includes a first surface and a second surface opposite to the first surface. The key sheet is detachably disposed on the touch sensing surface with the second surface facing toward the touch sensing surface. The second surface comprises at least one identification pattern for generating an attribute recognition signal when the at least one identification pattern contacts or approaches the touch sensing surface. The attribute recognition signal reflects features of the identification patterns and is used to determine a type of a controllable device. The features include one or a combination of a number of the identification patterns, a touch position of each identification pattern, and a shape of each identification pattern.

### CROSS-REFERENCE TO RELATED APPLICATION

This application claims the priority benefit of Taiwan application serial no. 102127496, filed on Jul. 31, 2013. The entirety of the above-mentioned patent application is hereby incorporated by reference herein and made a part of this specification.

### BACKGROUND

1. Field of the Invention

The present invention generally relates to a control system, and in particular, to a control system easy to change a function thereof and a method for defining the function of the control system.

2. Description of Related Art

With the arrival of the information appliance (IA) era, various products such as on-line gaming console, Smart phone, Net TV, or Smart TV appear more and more commonly in the modern life. Taking the Smart TV as an example, as the screen size of the Smart TV has continuously increased, if it is required to control the Smart TV placed in a longer distance, disposed with a larger screen, and configured with various functions, the design for the remote controller of the Smart TV would be very complicated. In short, in addition to the traditional key input function, the remote controller must be integrated with multiple input interfaces, so that users can watch programs, play games, and browse webs on the Smart TV by using the remote controller.

Predictably, the remote controller which combines keys of a traditional TV remote controller, a touchpad, a gaming key panel, and even alphanumeric keyboard would have a quite complicated structure, and require expensive hardware costs. In order to facilitate the users to operate with both hands, the size of the remote controller cannot be too large, which indirectly limits the size of each key and each input tool and makes the remote controller very inconvenient in use.

### SUMMARY

Accordingly, the present invention provides a control system and a method for defining a function thereof, which have features such as simple structure, low cost and easy for customization.

The present invention provides a control system comprising a touchpad and a key sheet. The touchpad comprises a touch sensing surface and the key sheet comprises a first surface and a second surface opposite to the first surface. The key sheet is detachably disposed on the touch sensing surface with the second surface of the key sheet facing toward the touch sensing surface. The second surface comprises at least one identification pattern for generating an attribute recognition signal when the at least one identification pattern contacts or approaches the touch sensing surface, and the attribute recognition signal reflects features of the identification pattern and is used to determine a type of a controllable device, wherein the features of the at least one identification pattern comprises one or a combination of a number of the at least one identification pattern, a touch position of each of the at least one identification pattern, and a shape of each of the at least one identification pattern.

In an embodiment of the present invention, the control system further comprises a control unit coupled to the touchpad. The control unit is configured to generate the attribute recognition signal according to the features of the at least one identification pattern when the at least one identification pattern contacts or approaches the touch sensing surface, determine the type of the controllable device according to the attribute recognition signal, and set a function of at least one operating region on the touch sensing surface.

In an embodiment of the present invention, the control unit generates the attribute recognition signal according to a recognition region of the touch sensing surface where the touch position of each of the at least one identification pattern is located.

In an embodiment of the present invention, the control unit generates the attribute recognition signal corresponding to a recognition region of the touch sensing surface and the number of the at least one identification pattern when the touch position of each of the at least one identification pattern is located in the recognition region.

In an embodiment of the present invention, the control unit generates the attribute recognition signal corresponding to a recognition region of the touch sensing surface and the shape of each of the at least one identification pattern when the touch position of each of the at least one identification pattern is located in the recognition region.

In an embodiment of the present invention, the control unit generates the attribute recognition signal according to a recognition region of the touch sensing surface where the touch position of each of the at least one identification pattern is located, the shape of each of the at least one identification pattern, and the number of the at least one identification pattern corresponding to each shape.

In an embodiment of the present invention, the control unit generates the attribute recognition signal corresponding to the number of the at least one identification pattern.

In an embodiment of the present invention, the control unit generates the attribute recognition signal corresponding to the shape of each of the at least one identification pattern.

In an embodiment of the present invention, the control unit generates the attribute recognition signal corresponding to the shape of each of the at least one identification pattern and the number of the at least one identification pattern corresponding to each shape.

In an embodiment of the present invention, wherein the first surface of the key sheet comprises at least one input component corresponding to the at least one operating region on the second surface. When a specific input component of the at least one input component is operated to result in a contact on the touch sensing surface, the control unit generates a control signal according to the function set for the operating region corresponding to the specific input component and transmits the control signal to the electronic device for controlling the electronic device, wherein the electronic device is conformed with the type of the controllable device.

In an embodiment of the present invention, the control unit generates the control signal according to the function set for the operating region corresponding to the specific input component on the first surface of the key sheet and a displacement and/or a pressure value of the contact and transmits the control signal to the electronic device for controlling the electronic device.

In an embodiment of the present invention, wherein a material of the key sheet is an elastic material comprising rubber, silicone, conductive rubber, or conductive silicone.

In an embodiment of the present invention, wherein the function comprises a key input function, a joystick function, a data scaling function, a hand writing function, and a data browsing function.

The present invention provides a method for defining a function of a control system, the control system comprises a touchpad and a key sheet, and the key sheet comprises a first surface and a second surface opposite to the first surface. In the method, it is determined whether the key sheet is disposed on the touch sensing surface with the second surface facing toward the touchpad. If yes, a type of a controllable device is determined according to an attribute recognition signal generated by the at least one identification pattern on the second surface contacting or approaching the touch sensing surface. The attribute recognition signal reflects features of the at least one identification pattern and the features of the at least one identification pattern comprise one or a combination of a number of the at least one identification pattern, a touch position of each of the at least one identification pattern, and a shape of each of the at least one identification pattern.

In an embodiment of the present invention, after the step of determining the type of the controllable device according to the attribute recognition signal generated by the at least one identification pattern on the second surface contacting or approaching the touch sensing surface, the method further comprises setting a function of each of at least one operating region on the touch sensing surface according to the type of the controllable device.

In an embodiment of the present invention, the method further comprises generating the attribute recognition signal according to an recognition region of the touch sensing surface where a touch position of each of the at least one identification pattern is located.

In an embodiment of the present invention, the method further comprises generating the attribute recognition signal corresponding to a recognition region of the touch sensing surface and the number of the at least one identification pattern when the touch position of each of the at least one identification pattern is located in the recognition region.

In an embodiment of the present invention, the method further comprises generating the attribute recognition signal corresponding to a recognition region of the touch sensing surface and the shape of each of the at least one identification pattern when touch position of each of the at least one identification pattern is located in the recognition region.

In an embodiment of the present invention, the method further comprises generating the attribute recognition signal according to a recognition region of the touch sensing surface where the touch position of each of the at least one identification pattern is located, the shape of each of the at least one identification pattern, and the number of the at least one identification pattern corresponding to each shape.

In an embodiment of the present invention, the method further comprises generating the attribute recognition signal corresponding to the number of the at least one identification pattern.

In an embodiment of the present invention, the method further comprises generating the attribute recognition signal corresponding to the shape of each of the at least one identification pattern.

In an embodiment of the present invention, the method further comprises generating the attribute recognition signal corresponding to the shape of each of the at least one identification pattern and the number of the at least one identification pattern corresponding to each shape.

In an embodiment of the present invention, the first surface of the key sheet comprises at least one input components corresponding to the at least one operating region, and after the step of setting the function of each of the at least one operating region on the touch sensing surface according to the type of the controllable device, the method further comprises generating a control signal according to the function set for the operating region corresponding to a specific input component of the at least one input component when the specific input component is operated to result in a contact on the touch sensing surface, and transmitting the control signal to an electronic device for controlling the electronic device, wherein the electronic device is conformed with the type of the controllable device.

In an embodiment of the present invention, the step of generating the control signal according to the specific input component corresponding to the function set for the operating region comprises generating the control signal according to the function set for the operating region corresponding to the specific input component on the first surface of the key sheet and a displacement and/or a pressure value of the contact.

In an embodiment of the present invention, wherein a material of the key sheet is an elastic material comprising rubber, silicone, conductive rubber, or conductive silicone.

In an embodiment of the present invention, wherein the function comprises a key input function, a joystick function, a data scaling function, a hand writing function, and a data browsing function.

Based on the above, the control system and the method for defining a function thereof identify features of at least one identification pattern on a key sheet by using a touch sensing surface of a touchpad, so as to determine the function of the control system and the type of device that can be controlled by the control system when the control system is configured with the key sheet. Accordingly, through disposing key sheet with different attributes, different type of operating function can be implemented by the control system.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram illustrating a control system according to an embodiment of the present invention.

FIG. 2 is an exploded view illustrating a control system according to an embodiment of the present invention.

FIG. 3 is schematic diagram illustrating a control system according to an embodiment of the present invention.

FIGS. 4A to 4D, 5A to 5B, 6A to 6B, 7A to 7C, 8A to 8B, 9A to 9B, and 10A to 10B are schematic diagrams illustrating features of the identification patterns according to embodiments of the present invention.

FIGS. 11A to 11B, 12A to 12B, 13A to 13B, and 14A to 14D are examples illustrating a control system with different functions according to embodiments of the present invention.

FIGS. 15, 16A, and 16B are sectional views of a control system according to embodiments of the present invention.

FIG. 17 is a flowchart illustrating a method for defining function of the control system according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

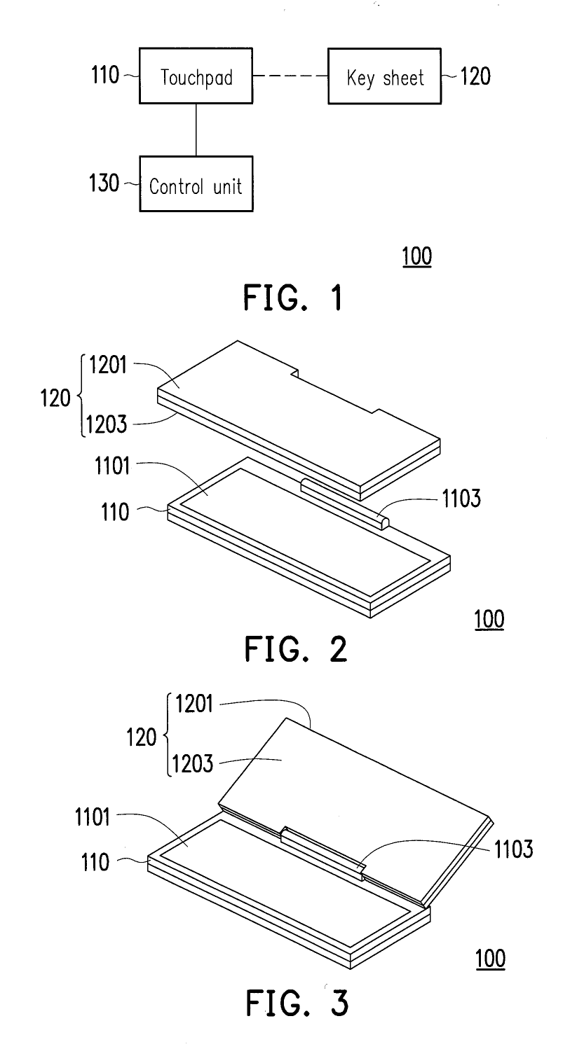

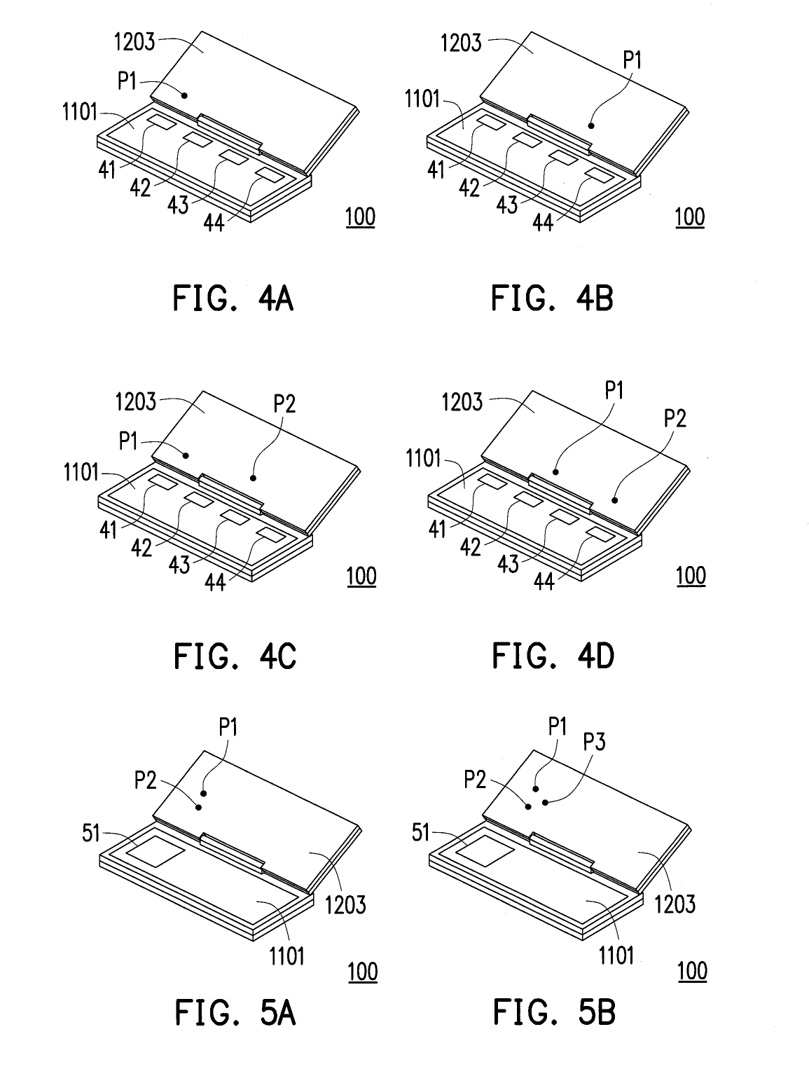

FIG. 1 is a block diagram illustrating a control system according to an embodiment of the present invention, and FIG. 2 is an exploded view of FIG. 1. With reference to FIG. 1 and FIG. 2, in the present embodiment, the control system 100 comprises a touchpad 110, a key sheet 120, and a control unit 130. The touchpad 110 comprises a touch sensing surface 1101, and the key sheet 120 comprises a first surface 1201 and a second surface 1203 opposite to the first surface 1201. In the present embodiment, the touchpad 110 and key sheet 120 have the same size, but the present invention is not limited thereto. In other embodiments, the size of the touchpad 110 may also be larger than the size of the key sheet 120.

The touchpad 110 is, for example, a resistive touch panel, a capacitive touch panel, a pressure-sensitive touchpad, an optical touch panel, an ultrasonic touch panel, or other types of sensing components. Furthermore, the touchpad 110 supports multi-touch. In the present embodiment, the control unit 130 is disposed inside the touchpad 110 and coupled to the touch sensing surface 1101, so as to generate a signal corresponding to a contact sensed by the touch sensing surface 1101. However, in another embodiment, the control unit 130 may also be disposed outside the touchpad 110 and receive the information relevant to the contact sensed by the touch sensing surface 1101 through a wired or wireless transmission technology and then accordingly generate a corresponding signal.

The material of the key sheet 120 is, for example, rubber, silicone, conductive rubber, conductive silicone, or any other elastic material. The first surface 1201 comprises at least one input component, which may be a key or a button protrudingly disposed on the first surface 1201, or a joystick penetrated through the first surface 1201. The second surface 1203 comprises at least one identification pattern with the same or different shape and each identification pattern is protrudingly disposed on the second surface 1203. In the present embodiment, the key sheet 120 does not comprise any circuit component, but the present invention is not limited thereto.

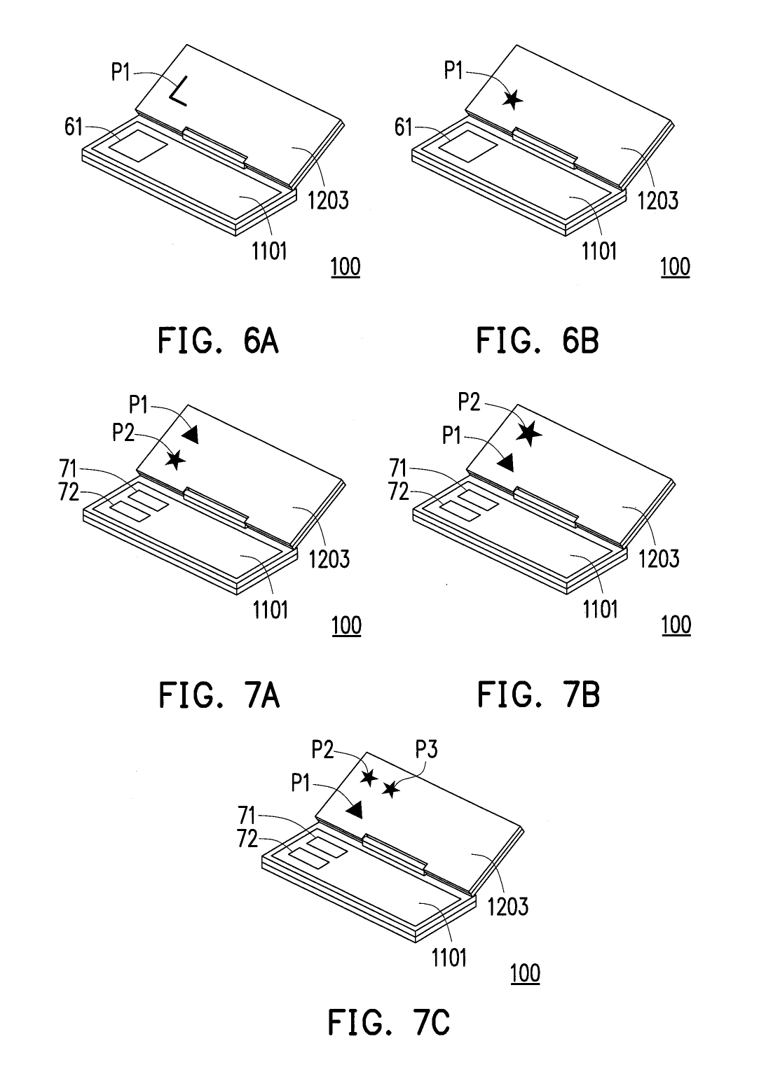

The touchpad 110 and the key sheet 120 are interconnected with each other by a detachable hinge 1103. FIG. 3 illustrates a state of opening the control system 100 to enable the key sheet 120 to turn from the touchpad 110 through the hinge 1103. When the control system 100 is closed, the key sheet 120 is disposed on the touch sensing surface 1101 of the touchpad 110 with the second surface 1203 facing toward the touch sensing surface 1101, that is, the key sheet 120 covers the touchpad 110. It should be noted that, since the key sheet 120 is detachably disposed on the touchpad 110, the control system 100 may change the key sheet with different attributes. When the key sheet with different attributes is attached, the control system 100 may produce different functions.

In detail, when the key sheet 120 is disposed on the touch sensing surface 1101 of the touchpad 110 with the second surface 1203 facing the touch sensing surface 1101, the sensing components inside the touchpad 110 may detect all the identification patterns on the second surface 1203 contact or approach the touch sensing surface 1101. The control unit 130 may first generate an attribute recognition signal reflecting the features of the identification patterns accordingly, and then determine the type of the device (referred to as a type of a controllable device hereinafter) which can be controlled by the control system 100 according to the attribute recognition signal. In the present embodiment, the features of the identification patterns include one or a combination of the number of the identification patterns, the contact position of each identification pattern on the touch sensing surface 1101, and the shape of each identification pattern. The type of the controllable device comprises desktop, notebook, tablet, All-in-One (AIO), Smart TV, or game console, but the present invention is not limited thereto. As for the key sheet with different attributes, since the number, shapes, and distribution positions of the identification patterns on the second surface are different, the control unit 130 may take advantage of the identification patterns to recognize which attribute of the key sheet is disposed in the control system 100.

Several examples are given below for illustrating how the control unit 130 generates the attribute recognition signal which reflects the features of the identification patterns.

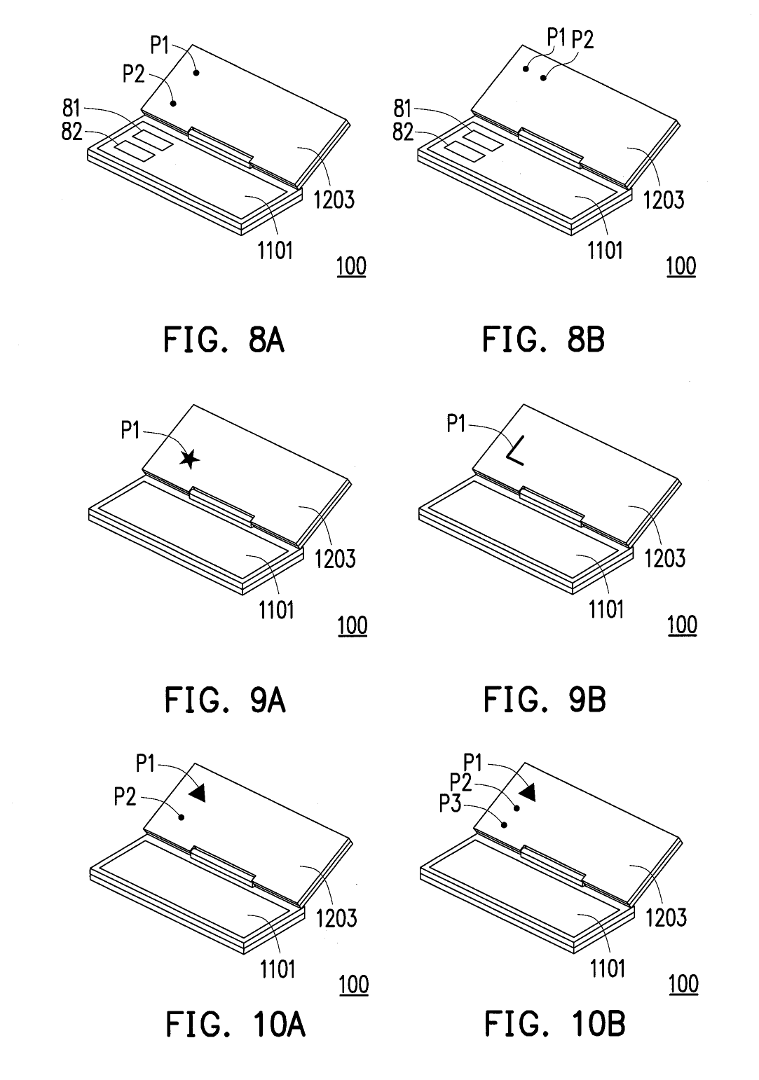

In an embodiment, the touch sensing surface 1101 comprises one or more recognition regions, and the recognition regions are, for example, located close to the edge of the touch sensing surface 1101, but the present invention is not limited thereto. When the touch sensing surface 1101 comprises several recognition regions, these recognition regions may be adjacent to each other or distributed over different locations on a touch sensing surface 1101. The control unit 130 generates the attribute recognition signal according to which recognition region on the touch sensing surface 1101 the contact position of each identification pattern on the second surface 1203 is located in. Assuming that the touch sensing surface 1101 includes four recognition regions 41, 42, 43, 44. In FIG. 4A, for example, if an identification pattern P1 is disposed on the second surface 1203 and contacts the recognition region 41 when the key sheet 120 covers on the touchpad 110, the control unit 130 may generate attribute recognition signal corresponding to the recognition region 41. In FIG. 4B, for example, if the identification pattern P1 on the second surface 1203 contacts the recognition region 43 when the key sheet 120 covers on the touchpad 110, the control unit 130 may generate the attribute recognition signal corresponding to recognition region 43. The control unit 130 generates the attribute recognition signal according to the recognition region where the contact position of each identification pattern is located when the number of the identification patterns on the second surface 1203 is larger than 1. Referring to both FIG. 4C and FIG. 4D, although the same number of the identification patterns are disposed on the second surface 1203, in FIG. 4C, the identification patterns P1 and P2 may contact the recognition regions 41 and 43 when the key sheet 120 covers the touchpad 110, and in FIG. 4D, the identification pattern P1 and P2 may contact the recognition region 42 and 44 when the key sheet 120 covers the touchpad 110. Therefore, the control unit 130 may generate different attribute recognition signal corresponding to the example of FIG. 4C and FIG. 4D, so as to present the key sheets with different attributes.

In an embodiment, the control unit 130 generates the attribute recognition signal corresponding to recognition region and the number of the identification patterns when the contact position of the identification pattern is located in the recognition region of the touch sensing surface 1101. In FIG. 5A, for example, two identification patterns P1 and P2 are disposed on the second surface 1203 and may contact the identification area 51 when the key sheet 120 covers the touchpad 110. Therefore, the control unit 130 may generate the attribute recognition signal corresponding to recognition region 51 and the number of the identification pattern (i.e. 2). In FIG. 5B, for example, three identification patterns P1, P2, and P3 are disposed on the second surface 1203. Although the three identification patterns may contact the recognition region 51 when the key sheet covers the touchpad 110, since the control unit 130 generates the attribute recognition signal according to the positions of the identification patterns and the number thereof, the control unit 130 may generate different attribute recognition signals in the examples of FIG. 5A and FIG. 5B, so as to represent the key sheets with different attributes.

In an embodiment, the control unit 130 may generate the attribute recognition signal corresponding to the recognition region and the shape of each of the identification patterns when the contact position of each identification pattern is located within the recognition region of the touch sensing surface 1101. In FIG. 6A, for example, an identification pattern P1 with a shape of character “L” is disposed on the second surface 1203 and contacts the identification area 61 when the key sheet 120 covers the touchpad 110. Accordingly, the control unit 130 generates the attribute recognition signal corresponding to the recognition region 61 and the identification pattern with a shape of character “L”. In FIG. 6B for example, an identification pattern P1 with a shape of star is disposed on the second surface 1203 and contacts the identification area 61 when the key sheet 120 covers the touchpad 110. Accordingly, the control unit 130 generates the attribute recognition signal corresponding to the recognition region 61 and the identification pattern with the shape of star. Although only one identification pattern is configured in the example of FIG. 6A and FIG. 6B, when the number of the identification patterns is larger than 1, the control unit 130 may generate the attribute recognition signal by using the shape of the identification pattern as one of the bases.

In an embodiment, the control unit 130 may generate the attribute recognition signal according to the recognition region of the touch sensing surface 1101 where the contact position of each identification pattern is located, the shape of each of the identification patterns, and the number of the identification patterns corresponding to each shape. In FIG. 7A, for example, an identification pattern P1 with a triangular shape and an identification pattern P2 with a star shape are disposed on the second surface 1203. When the key sheet 120 covers the touchpad 110, a contact of the identification pattern P1 with a triangular shape is detected on the recognition region 72 of the touch sensing surface 1101, a contact of the identification pattern P2 with a star shape is detected on the recognition region 71 of the touch sensing surface 1101, and the control unit 130 may generate the attribute recognition signal according to aforesaid information. In the example illustrated in FIG. 7B, although an identification pattern P1 with a triangular shape and an identification pattern P2 with a star shape are also disposed on the second surface 1203, since the recognition regions where the contact positions of the identification patterns are located are different from those in the example of FIG. 7A, the attribute recognition signal generated for the example of FIG. 7B by the control unit 130 is different from the attribute recognition signal generated for the example of FIG. 7B. Additionally, in the example of FIG. 7C, an identification pattern P1 with a triangular shape and two identification patterns P2 and P3 with a star shape are disposed on the second surface 1203. When the key sheet 120 covers the touchpad 110, a contact of the identification pattern P1 with a triangular shape is detected on the recognition region 71 of the touch sensing surface 1101, two contacts of the identification patterns P2 and P3 with a star shape are detected on the recognition region 72 of the touch sensing surface 1101, and the control unit 130 may generate the attribute recognition signal according to aforesaid information.

In an embodiment, the control unit 130 may generate the attribute recognition signal corresponding to the number of the identification patterns on the second surface 1203. To be specific, in the present embodiment, the number of the identification patterns is the only basis that the control unit 130 uses for generating the attribute recognition signal. For example, referring to both FIG. 8A and FIG. 8B, two identification patterns P1 and P2 are disposed on the second surface 1203 in FIG. 8A, and two identification patterns P1 and P2 are disposed on the second surface 1203 in FIG. 8B. As for the identification pattern P2, although the contact position thereof illustrated in the example of FIG. 8A is located in the recognition region 81, and the contact position illustrated in the example of FIG. 8B is located in the recognition region 82, since the number of the identification patterns on the second surface 1203 are the same in these two examples, the control unit 130 may generate the same attribute recognition signal.

It is noted that the recognition regions illustrated in the examples of FIG. 4A to FIG. 8B do not represent all of the recognition regions of the touch sensing surface 1101. That is to say, there may be other recognition regions on the touch sensing surface 1101, but are not depicted in FIG. 4A to FIG. 8B for the convenience of explanation.

In another embodiment below, the control unit 130 may only generate the attribute recognition signal according to the shape of each identification pattern. As shown in FIG. 9A, when the key sheet 120 covers the touchpad 110, a contact of the identification pattern P1 with a star shape is detected on the touch sensing surface 1101 and the control unit 130 may generate the attribute recognition signal corresponding to the star shape. In the example of FIG. 9B, when the key sheet 120 covers the touchpad 110, a contact of the identification pattern P1 with a shape of character “L” is detected on the touch sensing surface 1101, and the control unit 130 may generate the attribute recognition signal corresponding to the shape of character “L”. It should be noted that, although the examples illustrated in FIG. 9A and FIG. 9B both only comprise one identification pattern, when the number of the identification patterns is larger than 1, the control unit 130 may generate the attribute recognition signal further according to the shape of each identification pattern.

In an embodiment, the control unit 130 may generate the attribute recognition signal according to the shape of each identification pattern and the number of the identification patterns corresponding to each shape. In FIG. 10A, for example, an identification pattern P1 with a triangular shape and an identification pattern P2 with a circular shape are disposed on the second surface 1203, and the control unit 130 may generate the attribute recognition signal corresponding to the example of FIG. 10A accordingly. In FIG. 10B, an identification pattern P1 with a triangular shape and two identification patterns P2 and P3 with a circular shape are disposed on the second surface 1203, and therefore the attribute recognition signal generated by the control unit 130 accordingly is different from the attribute recognition signal generated for the example of FIG. 10A.

It is noted that, the features of the identification patterns such as the distribution and the number of the identification patterns on the second surface 1203, and the shape of the identification pattern described above are examples for illustration, but are not used to limit the scope of the present invention. In other words, any way of using the features of the identification patterns on the second surface 1203 of the key sheet to identify the attribute of the key sheet may be belonged to the scope of the present invention.

After generating the attribute recognition signal, the control unit 130 may determine the type of the controllable device accordingly, which is equivalent to determine the function of the control system 100. Afterward, the control unit 130 sets the function of each of at least one operating region on the touch sensing surface 1101 according to the type of the controllable device. In the present embodiment, the recognition region and the operating region on the touch sensing surface 1101 are not overlapped to each other. The function of each operating region may be the same or different. For example, the function of an operating region can be a key input function corresponding to keys including one or a combination of character keys, numeric keys, arrow keys, function keys, volume adjusting keys, a joystick function, a data scaling function, a hand writing function, or a data browsing function. When a contact on the operating region is detected by the touch sensing surface 1101, the control unit 130 may generate a control signal at least according to the function corresponding to the operating region, and then control the electronic device which is conformed with the type of the controllable device. In the present invention, the number of the operating region on the touch sensing surface 1101 is not limited. When the number of the operating region is 1, the control system 100 only provides one function, and when the number of the operating region is larger than 1, the control system 100 provides one or more functions.

In detail, all of the input components on the first surface 1201 of the key sheet 120 are corresponding to the positions of all of the operating regions on the touch sensing surface 1101. In an embodiment, when a specific input component of the input components is operated by a user to result in a contact on the touch sensing surface 1101, the control unit 130 generates a control signal according to the function set for the operating region corresponding to the specific input component, and transmits the control signal to the electronic device for operating the electronic device.

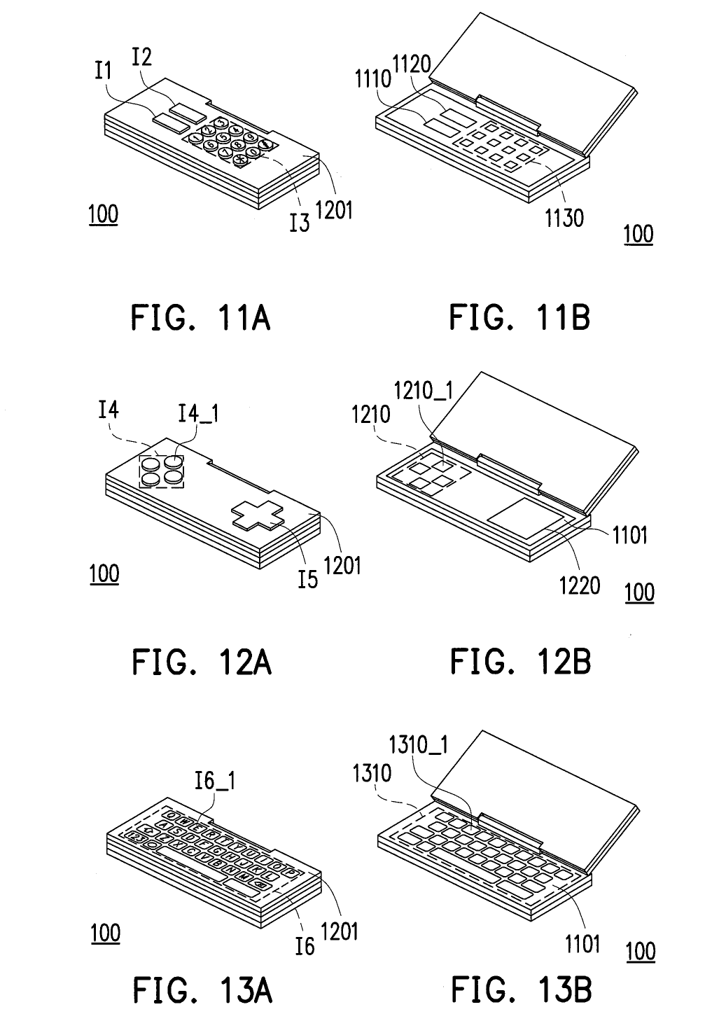

If the control system 130 determines the type of the controllable device is a Smart TV according to attribute recognition signal. Referring to both FIG. 11A and FIG. 11B, input components I1, I2, and I3 are disposed on the first surface 1201 of the key sheet 120, in which the input component I3 is constituted by twelve subsidiary input components. The control unit 130 defines operating region 1110, 1120, 1130 on the touch sensing surface 1101 and sets the function of each of the operating regions 1110, 1120, and 1130 according to such type of the controllable device (i.e. Smart TV), in which the operating region 1130 is constituted by twelve subsidiary operating regions. The operating regions 1110, 1120, and 1130 are corresponding to the input components I1, I2, and I3, and in the present embodiment, the function of the operating region 1110 is a volume up key function, the function of the operating region 1120 is a volume down key function, the function of the operating region 1130 includes functions of nine numeric keys and two function keys (which corresponds to the twelve subsidiary operating regions). For example, when the input component I1 is operated by the user (such as being pressed down) to result in a contact on the touch sensing surface 1101, the control unit 130 generates the control signal according to the function of volume up key set for the operating region 1110 corresponding to the input component I1, and transmits the control signal to the Smart TV to increase the volume of the Smart TV.

If the control system 130 determines the type of the controllable device is a game console according to attribute recognition signal. Referring to both FIG. 12A and FIG. 12B, input components I4 and I5 are disposed on the first surface 1201 of the key sheet 120, in which the input component I4 is constituted by four subsidiary input components. The control unit 130 defines the operating regions 1210 and 1220 and sets the functions of each of the operating regions 1210 and 1220 according to such type of the controllable device (i.e. game console), in which the operating region 1210 is constituted by four subsidiary operating regions. The operating regions 1210 and 1220 are corresponding to the input components I4 and I5, in which the operating region 1210 comprises four subsidiary operating regions corresponding to the four subsidiary input components of the input component I4. In the present embodiment, the function of the operating region 1210 are four function keys (which corresponds to the four subsidiary operating regions), the function of the operating region 1220 is a four-way key. For example, when the input component I4 is operated by the user (such as being pressed down) to result in a contact on the touch sensing surface 1101, the control unit 130 generates the control signal according to the function of the function key set for the operating region 1210_1 corresponding to the input component I4_1, and transmits the control signal to the game console for controlling the game console.

If the control system 130 determines the type of the controllable device is a notebook according to attribute recognition signal. Referring to both FIG. 13A and FIG. 13B, an input component I6 is disposed on the first surface of the key sheet 120 and the input component I6 comprises subsidiary input components corresponding to twenty-six character keys and six subsidiary input components corresponding to six function keys. The control unit 130 defines the operating region 1310 and sets the functions of the operating region 1310 according to such type of the controllable device (i.e. notebook), in which the operating region 1310 is constituted by thirty-two subsidiary operating regions, and the arrangement of the subsidiary operating regions in the operating region 1310 is the same as that of the subsidiary input components in the input component I6. The subsidiary operating region and the subsidiary input component which have the same position are corresponding to each other. When the subsidiary input component I6_1 of the input component I6 is operated by the user (such as being pressed down) to result in a contact on the touch sensing surface 1101, the control unit 130 generates the control signal according to the function of the function key set for the operating region 1310_1 corresponding to the input component I6_1, and transmits the control signal to the notebook to complete the operation of inputting character “E”.

In another embodiment, the control unit 130 further generates the control signal according to the function set for the operating region corresponding to a specific input component on the first surface 1201 of the key sheet 120 and the displacement and/or the pressure of the contact.

For example, it is assumed that the control unit 130 determines the type of the controllable device is a notebook according to the attribute recognition signal. As shown in FIG. 14A, the first surface 1201 of the key sheet 120 comprises a slidable input component I7, the input component I7 is corresponding to the only one operating region on the touch sensing surface 1101, and the function of the operating region is a data scaling function, such as font zooming. When the input component I7 is operated by the user (such as being pressed down) to result in a contact on the touch sensing surface 1101, the control unit 130 generates the control signal according to the function of font zooming set for the operating region corresponding to the input component I7, and transmits the control signal to the notebook. As shown in FIG. 14B, the characters in the region A1 corresponding to the current position of the input component I7 on the screen S of the notebook is enlarged. If the user continuously presses the input component I7 and moves the same toward the bottom right corner of the first surface 1201 (as shown in FIG. 14C), the control signal generated accordingly by the control unit 130 is able to enlarge the characters in the region A2 corresponding to the current position of the input component I7 on the screen S of the notebook.

In another embodiment, if the function corresponding to the only one operating region on the touch sensing surface 1101 is a hand writing input function of a certain type of input component (e.g. a pen of a certain color or a certain type), when the user operates the slidable input component on the first surface 1201 of the key sheet 120, an effect of hand writing is generated on the screen of the electronic device which is controlled by the control system 100.

In further another embodiment, the function corresponding to a certain operating region on the touch sensing surface 1101 is a data browsing function. When the input component corresponding to the operating region is operated by the user (such as being pressed down) to result in a contact on the touch sensing surface 1101, the control unit 130 generates the control signal according to the data browsing function and the pressure of the contact, and transmits the control signal to the electronic device which is controlled by the control system 100 so as to adjust the amount of data being browsed. For example, when a menu is displayed on the screen of the electronic device if the pressure is higher, the degree that the sub-menu being expanded by the control signal generated by the control unit 130 is higher, so as to facilitate the user seeing more levels of menu content.

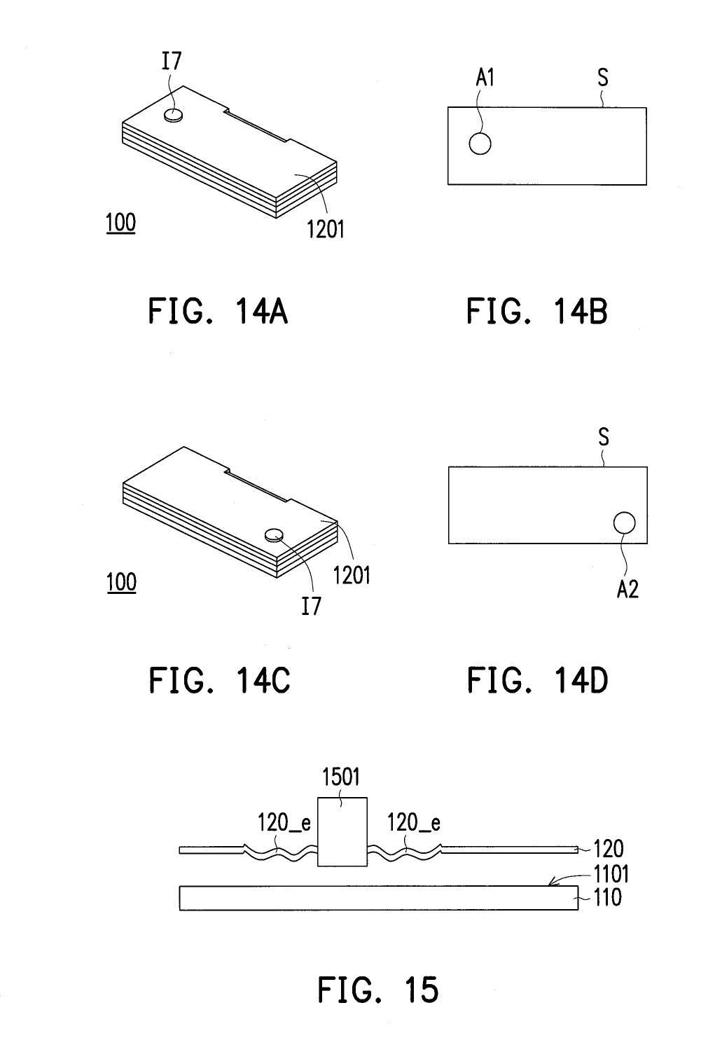

FIG. 15 is a sectional view of a control system according to an embodiment of the present invention. Referring to FIG. 15, it is assumed that the function set for the operating area corresponding to the input component 1501 is a lateral joystick function. When the user operates the input component 1501, since an elastic recovery structure 120_{—}e is disposed around the input component 1501 on the key sheet 120, the user can perform a directional operation like the operation of joystick on the input component 1501. In other embodiment, it is assumed that the key sheet is disposed between an upper and a lower cover, and the elastic recovery structure 120_{—}e is implemented on the lower cover. When being operated by the user, the contact of the input component 1501 on the touch sensing surface 1101 forms a trace of a circular shifting motion, and the control unit 130 may calculate the displacement of contact according to the trace so as to generate the control signal to be transmitted to the electronic device. Alternatively, the control unit 130 may also generate the control signal to be transmitted to the electronic device according to the displacement of contact and the pressure formed by the input component 1501 on the of touch sensing surface 1101. Therefore, the user may take advantage of the control system 100 to get the feeling of operating the electronic device by using a lateral key on a joystick.

FIGS. 16A and 16B are sectional views of a control system according to an embodiment of the present invention. In the present embodiment, it is assumed that the function set for the operating area corresponding to the input component 1601 is the lateral key input function. When the user moves the input component 1601 along the direction of the arrow 1605, the input component 1601 is moved forward and backward on the touch sensing surface 1101. The control unit 130 generates a control signal for controlling the electronic device according to the displacement of the shift movement. Therefore, the user can use the control system 100 to obtain a feeling of operating the electronic device by using a lateral key on a remote controller.

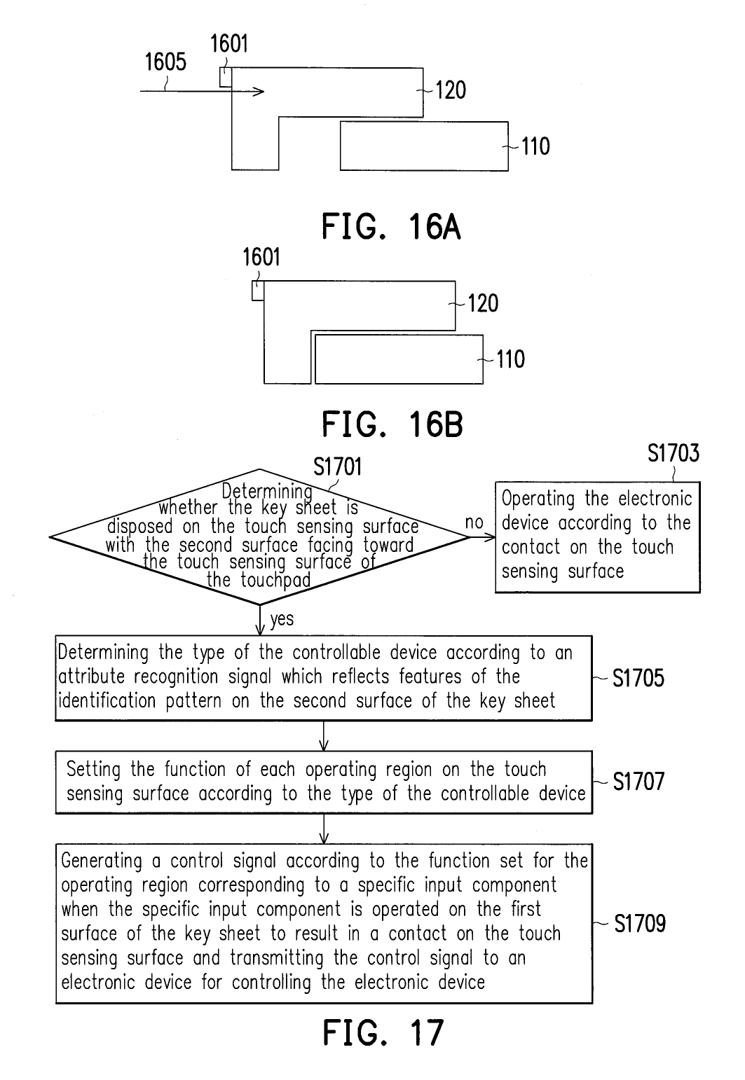

FIG. 17 is a flowchart illustrating a method for defining functions of the control system according to an embodiment of the present invention. Referring to FIG. 17, the control unit 130 determines whether the key sheet 120 is disposed on the touch sensing surface 1101 with the second surface 1203 facing toward the touch sensing surface 1101 of the touchpad 110 (step S1701).

If the determination result of the step S1701 is no, the control system 110 may control the electronic device according to the contact of the touch sensing surface 1101 (step S1703). That is, in such case, the control system 100 is equivalent to a regular touch input tool, and the user can use the touch sensing surface 1101 to control electronic device to execute a corresponding operation.

If the determination result of the step S1701 is yes, the control unit 130 determines that the type of the controllable device controlled by the control system 100 according to the attribute recognition signal, in which the attribute recognition signal reflects features of the identification patterns on the second surface 1203 of the key sheet 120 (step S1705).

Next, the control unit 130 sets the function of each operating region on the touch sensing surface 1101 according to the type of the controllable device (step S1707), and the control unit 130 generates a control signal according to the function set for the operating region corresponding to a specific input component when the specific input component is operated on the first surface 1201 of the key sheet 120 to result in a contact on the touch sensing surface 1101 and transmits the control signal to an electronic device for controlling the electronic device (step S1709).

To sum up, the present invention enables the control system to become a remote controller which comprises different functions and can control different controllable devices through identifying the attribute of the key sheet. Since the key sheet is a replaceable component, through changing the key sheet with different attribute, the control system can generate different functions. Accordingly, a control system with simplified structure, simplified circuit, easy to customize and ergonomics correspondence is provided.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A control system, comprising:
a touchpad comprising a touch sensing surface; and
a key sheet comprising a first surface and a second surface opposite to the first surface, wherein the key sheet is detachably disposed on the touch sensing surface with the second surface facing toward the touch sensing surface, the second surface comprises at least one identification pattern for generating an attribute recognition signal when the at least one identification pattern contacts or approaches the touch sensing surface, and the attribute recognition signal reflects features of the at least one identification pattern and is used to determine a type of a controllable device, wherein the features of the at least one identification pattern comprise one or a combination of a number of the at least one identification pattern, a touch position of each of the at least one identification pattern, and a shape of each of the at least one identification pattern.

2. The control system according to claim 1, further comprising:
a control unit, coupled to the touchpad, and configured to generate the attribute recognition signal according to the features of the at least one identification pattern when the at least one identification pattern contacts or approaches the touch sensing surface, determine the type of the controllable device according to the attribute recognition signal, and set a function of at least one operating region on the touch sensing surface.

3. The control system according to claim 2, wherein the control unit generates the attribute recognition signal according to a recognition region of the touch sensing surface where the touch position of each of the at least one identification pattern is located.

4. The control system according to claim 2, wherein the control unit generates the attribute recognition signal corresponding to a recognition region of the touch sensing surface and the number of the at least one identification pattern when the touch position of each of the at least one identification pattern is located in the recognition region.

5. The control system according to claim 2, wherein the control unit generates the attribute recognition signal corresponding to a recognition region of the touch sensing surface and the shape of each of the at least one identification pattern when the touch position of each of the at least one identification pattern is located in the recognition region.

6. The control system according to claim 2, wherein the control unit generates the attribute recognition signal according to a recognition region of the touch sensing surface where the touch position of each of the at least one identification pattern is located, the shape of each of the at least one identification pattern, and the number of the at least one identification pattern corresponding to each shape.

7. The control system according to claim 2, wherein the control unit generates the attribute recognition signal corresponding to the number of the at least one identification pattern.

8. The control system according to claim 2, wherein the control unit generates the attribute recognition signal corresponding to the shape of each of the at least one identification pattern.

9. The control system according to claim 2, wherein the control unit generates the attribute recognition signal corresponding to the shape of each of the at least one identification pattern and the number of the at least one identification pattern corresponding to each shape.

10. The control system according to claim 2, wherein the first surface of the key sheet comprises at least one input component corresponding to the at least one operating region on the second surface, and
when a specific input component of the at least one input component is operated to result in a contact on the touch sensing surface, the control unit generates a control signal according to the function set for the operating region corresponding to the specific input component and transmits the control signal to an electronic device for controlling the electronic device, wherein the electronic device is conformed with the type of the controllable device.

11. The control system according to claim 10, wherein the control unit generates the control signal according to the function set for the operating region corresponding to the specific input component on the first surface of the key sheet and a displacement and/or a pressure of the contact and transmits the control signal to the electronic device for controlling the electronic device.

12. The control system according to claim 11, wherein a material of the key sheet is an elastic material comprising rubber, silicone, conductive rubber, or conductive silicone.

13. The control system according to claim 2, wherein the function comprises a key input function, a joystick function, a data scaling function, a hand writing function, and a data browsing function.

14. A method for defining a function of a control system, the control system comprises a touchpad and a key sheet, the key sheet comprises a first surface and a second surface opposite to the first surface, the method comprising:
determining whether the key sheet is disposed on the touch sensing surface with the second surface facing toward a touch sensing surface of the touchpad; and
if yes, determining a type of a controllable device according to an attribute recognition signal generated by the at least one identification pattern on the second surface contacting or approaching the touch sensing surface, wherein the attribute recognition signal reflects features of the at least one identification pattern and the features of the at least one identification pattern comprise one or a combination of a number of the at least one identification pattern, a touch position of each of the at least one identification pattern, and a shape of each of the at least one identification pattern.

15. The method for defining function of the control system according to claim 14, wherein after the step of determining the type of the controllable device according to the attribute recognition signal generated by the at least one identification pattern on the second surface contacting or approaching the touch sensing surface, the method further comprises:
setting a function of each of at least one operating region on the touch sensing surface according to the type of the controllable device.

16. The method for defining function of the control system according to claim 14, further comprising:
generating the attribute recognition signal corresponding to a recognition region of the touch sensing surface when the touch position of each of the at least one identification pattern is located in the recognition region.

17. The method for defining function of the control system according to claim 14, further comprising:
generating the attribute recognition signal corresponding to a recognition region of the touch sensing surface and the number of the at least one identification pattern when the touch position of each of the at least one identification pattern is located in the recognition region.

18. The method for defining function of the control system according to claim 14, further comprising:
generating the attribute recognition signal corresponding to a recognition region of the touch sensing surface and the shape of each of the at least one identification pattern when touch position of each of the at least one identification pattern is located in the recognition region.

19. The method for defining function of the control system according to claim 14, further comprising:
generating the attribute recognition signal according to a recognition region of the touch sensing surface where the touch position of each of the at least one identification pattern is located, the shape of each of the at least one identification pattern, and the number of the at least one identification pattern corresponding to each shape.

20. The method for defining function of the control system according to claim 14, further comprising:
generating the attribute recognition signal corresponding to the number of the at least one identification pattern.

21. The method for defining function of the control system according to claim 14, further comprising:
generating the attribute recognition signal corresponding to the shape of each of the at least one identification pattern.

22. The method for defining function of the control system according to claim 14, further comprising:
generating the attribute recognition signal corresponding to the shape of each of the at least one identification pattern and the number of the at least one identification pattern corresponding to each shape.

23. The method for defining function of the control system according to claim 15, wherein the first surface of the key sheet comprises at least one input component corresponding to the at least one operating region, and after the step of setting the function of each of the at least one operating region on the touch sensing surface according to the type of the controllable device, the method further comprises:
generating a control signal according to the function set for the operating region corresponding to a specific input component of the at least one input component when the specific input component is operated to result in a contact on the touch sensing surface; and
transmitting the control signal to an electronic device for controlling the electronic device, wherein the electronic device is conformed with the type of the controllable device.

24. The method for defining function of the control system according to claim 23, wherein the step of generating the control signal according to the specific input component corresponding to the function set for the operating region further comprises:
generating the control signal according to the function set for the operating region corresponding to the specific input component and a displacement and/or a pressure of the contact.

25. The method for defining function of the control system according to claim 24, wherein a material of the key sheet is an elastic material comprising rubber, silicone, conductive rubber, or conductive silicone.

26. The method for defining function of the control system according to claim 23, wherein the function comprises a key input function, a joystick function, a data scaling function, a hand writing function, and a data browsing function.
